(19) United States
(12) Patent Application Publication
(10) Pub. No.: US 2014/0009614 A1
(43) Pub. Date: Jan. 9, 2014

(54) APPARATUS AND METHOD FOR DETECTING A THREE DIMENSIONAL OBJECT USING AN IMAGE AROUND A VEHICLE

(71) Applicant: HYUNDAI MOTOR COMPANY, Seoul (KR)

(72) Inventors: Dae Joong Yoon, Hwaseong (KR); Jae Seob Choi, Hwaseong (KR); Eu Gene Chang, Gunpo (KR)

(73) Assignee: HYUNDAI MOTOR COMPANY, Seoul (KR)

(21) Appl. No.: 13/689,192

(22) Filed: Nov. 29, 2012

(30) Foreign Application Priority Data
Jul. 5, 2012 (KR) 10-2012-0073147

(51) Int. Cl. G06K 9/00

(52) U.S. Cl. CPC G06K 9/00791
USPC 348/148

(57) ABSTRACT

An apparatus for detecting a three dimensional object using an image around a vehicle includes a plurality of imaging devices disposed on a front, a rear, a left side, and a right side of the vehicle; a processor configured to: collect an image of the front, the rear, the left side, and the right side of the vehicle through a virtual imaging device; generate a composite image by compounding a plurality of top view images of the image; extract a boundary pattern of the plurality of top view images in each boundary area; compare the boundary pattern of the plurality of top view images to analyze a correlation between a plurality of neighboring images in each boundary area; and detect a three dimensional object according to the correlation between the plurality of neighboring images in each boundary area.

### CROSS-REFERENCES TO RELATED APPLICATIONS

This application claims priority to Korean patent application No. 10-2012-0073147 filed on Jul. 5, 2012, the disclosure of which is hereby incorporated in its entirety by reference.

### BACKGROUND OF THE INVENTION

1. Field of the Invention

The present invention relates to an apparatus and a method for detecting a three dimensional object using an image around a vehicle, and more particularly, to an apparatus and a method for detecting a three dimensional object located at a boundary area by analyzing a correlation of boundary patterns between front, rear, left, and right top view images of a vehicle.

2. Description of the Related Art

An around view monitoring (AVM) system is a system which converts a view of an image photographed through an imaging device disposed on front, rear, left, and right sides of a vehicle to be displayed in one image. Therefore, a driver may identify an object located around the vehicle through the around view monitoring system through one image.

However, the around view monitoring system provides a composite image using a plurality of images obtained by imaging devices on the front, rear, left, and right sides of a vehicle leaving potential blind spots at a boundary area between the plurality images in the composite image due to a difference in angle of view of each imaging device.

When there may be a three dimensional (3D) object in the blind spot, the object may not appear in the composite image or may appear in only one image. When the 3D object appears in only one image, the driver may experience difficulty in recognizing the object before it is clearly shown in the composite image.

### SUMMARY OF THE INVENTION

Accordingly, the present invention provides an apparatus and a method for detecting a 3D object using an image around a vehicle in which boundary patterns between neighboring images are compared to analyze a correlation thereof, thereby detecting a 3D image located at each boundary area in the composite image, the boundary pattern may be extracted from a boundary area between top view images in a composite image obtained by combining top view images of front, rear, left, and right sides of a vehicle.

In addition, the present invention provides an apparatus and a method for detecting a 3D object using an image around a vehicle in which a 3D object located at each boundary area of a composite image is detected to be outputted so a driver may easily detect the object located in a blind spot.

In accordance with an embodiment of the present invention, an apparatus for detecting a 3D object using an image around a vehicle, includes a plurality of units executed by a processor in a controller. The plurality of units including: an image obtaining unit configured to collect an image of front, rear, left, and right sides of the vehicle through a virtual imagine device generated using a mathematic model of imaging devices provided on the front, rear, left and right sides of the vehicle; an image compounding unit configured to generate a composite image by compounding top view images of the image of the front, rear, left, and right sides of the vehicle captured by the image obtaining unit; a boundary pattern extraction unit configured to analyze a boundary area between the top view images of the front, rear, left, and right sides of the vehicle from the composite image to extract a boundary pattern of the top view images of the front, rear, left, and right sides of the vehicle in each boundary area; a correlation analysis unit configured to compare the boundary pattern of the top view images of the front, rear, left, and right sides of the vehicle extracted by the boundary pattern extraction unit to analyze a correlation between neighboring images in the each boundary area; and a three dimensional (3D) object detection unit configured to detect a 3D object located in the each boundary area according to the correlation between the neighboring images in the each boundary area. The boundary pattern includes at least one of a brightness, a color, and a character value in a pixel or a block of the top view images of the front, rear, left, and right sides of the vehicle in the boundary area. The correlation analysis unit analyzes a higher correlation when a difference of the boundary pattern between the neighboring images in the each boundary area is lower and analyzes a lower correlation when a difference of the boundary pattern between the neighboring images in the each boundary area is higher. The 3D object detection unit detects the three dimensional object from the boundary area having a lower correlation between the neighboring images according to an analysis result of the correlation analysis unit.

In another embodiment of the present invention, the method of detecting a 3D object using an image around a vehicle, includes: capturing an image of front, rear, left, and right sides of the vehicle through a virtual imaging device generated using a mathematic model of imaging units disposed on the front, rear, left and right sides of the vehicle; generating, by a processor in a controller, a composite image by compounding a plurality of top view images of the image of the front, rear, left, and right sides of the vehicle; analyzing, by the processor, a boundary area between the plurality of top view images of the front, rear, left, and right sides of the vehicle from the composite image to extract a boundary pattern of the plurality of top view images of the front, rear, left, and right sides of the vehicle in each boundary area; comparing, by the processor, the boundary pattern of the plurality of top view images of the front, rear, left, and right sides of the vehicle to analyze a correlation between neighboring images in the each boundary area; and detecting, by the processor, a 3D object located in the each boundary area according to the correlation between the neighboring images in the each boundary area. The boundary pattern may include at least one of a brightness, a color, and a character value in a pixel or a block of the plurality of top view images of the front, rear, left, and right sides of the vehicle in the boundary area. The analyzing the correlation may include analyzing, by the processor, a higher correlation when a difference of the boundary pattern between the plurality of neighboring images in the each boundary area is lower and analyzing, by the processor, a lower correlation when a difference of the boundary pattern between the plurality of neighboring images in the each boundary area is higher. The detecting of the 3D object may include detecting, by the processor, the 3D object from the boundary area having a lower correlation between the plurality of neighboring images according to an analysis result of the analyzing the correlation.

### BRIEF DESCRIPTION OF THE DRAWINGS

The objects, features and advantages of the present invention will be more apparent from the following detailed description in conjunction with the accompanying drawings, in which:

FIG. 1 is an exemplary view illustrating an operation of capturing an image in an around view monitoring system according to an exemplary embodiment of the present invention;

FIG. 2 is an exemplary block diagram illustrating a configuration of an apparatus for detecting a three dimensional object using an image around a vehicle according to an exemplary embodiment the present invention;

FIG. 3 is an exemplary view illustrating an operation of compounding an image in an apparatus for detecting a three dimensional object using an image around a vehicle according to an exemplary embodiment the present invention;

FIGS. 4 through 7 are exemplary views illustrating an operation of detecting a three dimensional object in an apparatus for detecting a three dimensional object using an image around a vehicle according to an exemplary embodiment the present invention; and

FIG. 8 is an exemplary flow chart illustrating a method of detecting a three dimensional object using an image around a vehicle according to an exemplary embodiment the present invention.

### DETAILED DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

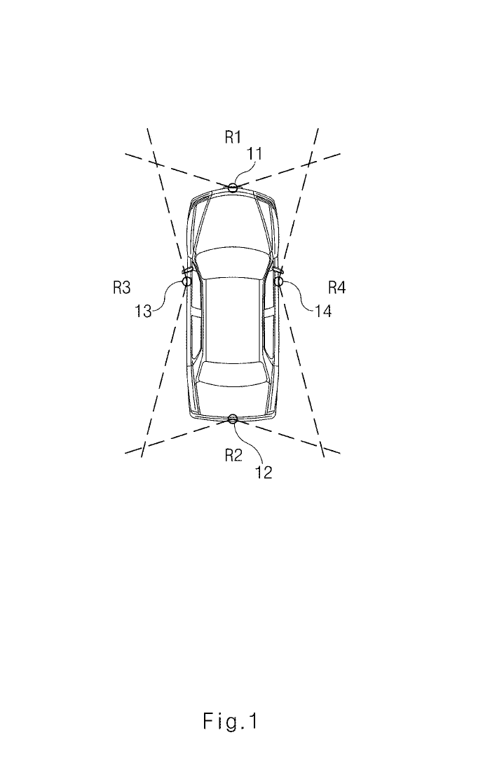

FIG. 1 is an exemplary view illustrating an operation of capturing an image in an around view monitoring system according to an exemplary embodiment of the present invention.

Referring to FIG. 1, an apparatus for detecting a three dimensional object (hereinafter, “3D object detection apparatus”) using an image around a vehicle may detect a 3D object around a vehicle by using an image used in an around view monitoring (AVM) system. The AVM system may be equipped with an imaging device disposed on an exterior of the vehicle and may monitor a surrounding area of the vehicle through an image photographed by a corresponding imaging device.

In the AVM system, a plurality of imaging devices 11, 12, 13, 14 may be disposed on a front, a rear, a left side and a right side of the vehicle and images of a front area R1, a rear area R2, a left area R3, and a right area R4 of the vehicle may be photographed through each respective imaging devices 11, 12, 13, 14 disposed on the front, rear, left side and right side of the vehicle and may be compounded and converted into a top view image, wherein the top view image may be displayed through a screen on a display unit. Thus, a driver may recognize the surrounding area of the vehicle by monitoring the top view image provided through the AVM system.

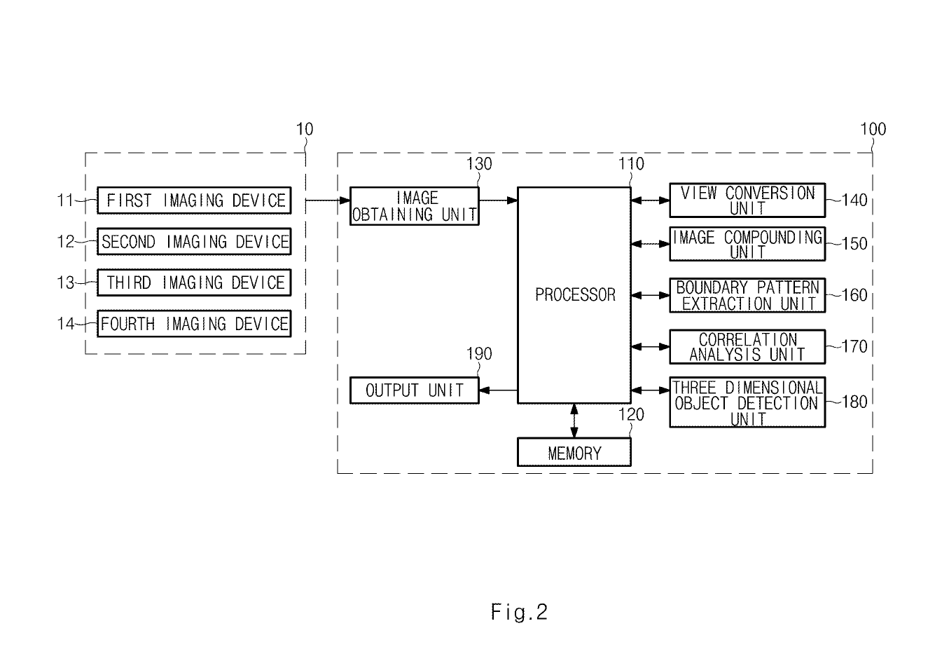

In the three dimensional object detection apparatus according to the present invention, each imaging device applied to the AVM system may be used and a pattern of a boundary area of an image captured through each imaging device may be analyzed to detect a 3D object such as a stone located near the vehicle. A detailed description of an exemplary configuration of the 3D object detection apparatus will be described with reference to an exemplary embodiment of FIG. 2.

FIG. 2 is an exemplary block diagram illustrating a configuration of an apparatus for detecting a 3D object using an image around a vehicle according to the present invention.

Referring to FIG. 2, the 3D object detection apparatus according to the present invention may include a plurality of units executed by a processor 110 in a controller 100 having a memory 120. The plurality of units include: an image obtaining unit 130, a view conversion unit 140, an image compounding unit 150, a boundary pattern extraction unit 160, a correlation analysis unit 170, a three dimensional object detection unit 180, and an output unit 190. Here, the processor 110 may control an operation of each element of the three dimensional object detection apparatus.

The memory 120 may store a setting value for an operation of detecting the 3D object of the three dimensional object detection apparatus. In addition, the memory 120 may store an image photographed through the plurality of imaging devices 10, a composite image, and a data extracted from each image. Furthermore, the memory 120 may store information of a detected three dimensional object as a result of analyzing each image.

The image obtaining unit 130 may collect an image photographed by a plurality of imaging devices 10 disposed on an exterior of the vehicle.

Moreover, the plurality of imaging devices 10 disposed on the exterior of the vehicle may include a first imaging device 11, a second imaging device 12, a third imaging device 13, and a fourth imaging device 14 disposed on a front, a rear, a left side, and a right side of the vehicle. The plurality of imaging devices 10 may be disposed on the front, the rear, the left side and the right side of the vehicle, respectively, however it should be noted that other imaging devices may be additionally provided.

In other words, the image obtaining unit 130 may collect, by the processor, images of the front, rear, left and right sides of the vehicle photographed through the first imaging device 11, the second imaging device 12, the third imaging device 13, and the fourth imaging device 14, and the processor 110 may store the images collected by the image obtaining unit 130 in the memory 120.

The view conversion unit 140 may convert, by the processor, a view of images of the front, rear, left and right sides of the vehicle collected by the image obtaining unit 130. In particular, the view conversion unit 140 may generate, by the processor, a top view image by converting the view of the plurality of images of the front, rear, left and right sides of the vehicle into a top view. Additionally, the image compounding unit 150 may generate, by the processor, a composite image by compounding the top view image of the view of the front, rear, left and right sides of the vehicle from the view conversion unit 140 into one image.

In the exemplary embodiment of FIG. 2, the view conversion unit 140 and the image compounding unit 150 may be separate units in the three dimensional object detection apparatus; however, according to another embodiment, a composite image may be inputted from the AVM system to be used, whereby the view conversion unit 140 and the image compounding unit 150 may be omitted. In other words, the image obtaining unit 130 may collect a composite image of top view images of the front, rear, left and right sides of the vehicle from the AVM system.

Moreover, the boundary pattern extraction unit 160 may extract and analyze, by the processor, a boundary area between the plurality of top view images of the front, rear, left and right sides of the vehicle from the composite image of the plurality of top view images of the front, rear, left and right sides of the vehicle. In particular, the boundary pattern extraction unit 160 may extract, by the processor, a boundary pattern of the plurality of top view images of the front, rear, left and right sides of the vehicle in each boundary area.

Furthermore, the boundary pattern may include at least one of brightness, color, and a characteristic value in a pixel or a block corresponding to the plurality of top view images of the front, rear, left and right top view images of the vehicle in each boundary area between the plurality of top view images.

In an exemplary embodiment, the boundary pattern extraction unit 160 may extract, by the processor, at least one of the brightness, the color, a pixel value, a block value, and the characteristic value of each top view image in the boundary area between top view images of the front and right sides of the vehicle. Similarly, the boundary pattern extraction unit 160 may extract, by the processor, at least one of the brightness, the color, the pixel value, the block value, and the characteristic value of each top view image in the boundary area between top view images of the rear and right sides, in the boundary area between top view images of the rear and left sides of the vehicle, and in the boundary area between the front and left sides of the vehicle.

The correlation analysis unit 170 may compare, by the processor, the boundary pattern of the plurality of top view images of the front, rear, left and right sides of the vehicle extracted by the boundary pattern extraction unit 160 to analyze a correlation between a plurality of neighboring images in each boundary area of the composite image. In particular, the plurality of neighboring images may refer to images facing each other in each boundary area of the composite image. For example, in a boundary area in which the plurality of top view images of the front and right sides of the vehicle face each other, the neighboring image of the top view image on the front side may be the top view image on the right side.

Furthermore, the correlation analysis unit 170 may analyze, by the processor, the correlation between the plurality of neighboring images in a corresponding boundary area based on a difference of the boundary pattern between the plurality of neighboring images in each boundary area of the composite image. Particularly, the correlation analysis unit 170 may analyze a higher correlation when the difference of the boundary pattern between the neighboring images in each boundary area is smaller and may analyze a lower correlation when the difference of the boundary pattern is greater.

The three dimensional object detection unit 180 may detect, by the processor, the 3D object located in each boundary area according to the correlation between the neighboring images in each boundary area of the composite image. In particular, the three dimensional object detection unit 180 may detect the 3D object from the boundary area having a lower correlation between the neighboring images in the composite image.

In an exemplary embodiment, the three dimensional object detection unit 180 may determine, by the processor, that the three dimensional object is located in a corresponding boundary area when a difference of brightness or color between the neighboring images in the boundary area of the composite image is greater. When determined by the three dimensional object detection unit 180 that the 3D object is detected, the output unit 190 may output, by the processor, a message notifying of the detection of the 3D object. In particular, the output unit 190 may output a location at which the 3D object is detected.

Furthermore, the output unit 190 may be a display such as a monitor, a touch screen, or a navigation, and a voice output means such as a speaker. Thus, the message outputted by the output unit 190 is not limited to only one form but may be varied according to an embodiment.

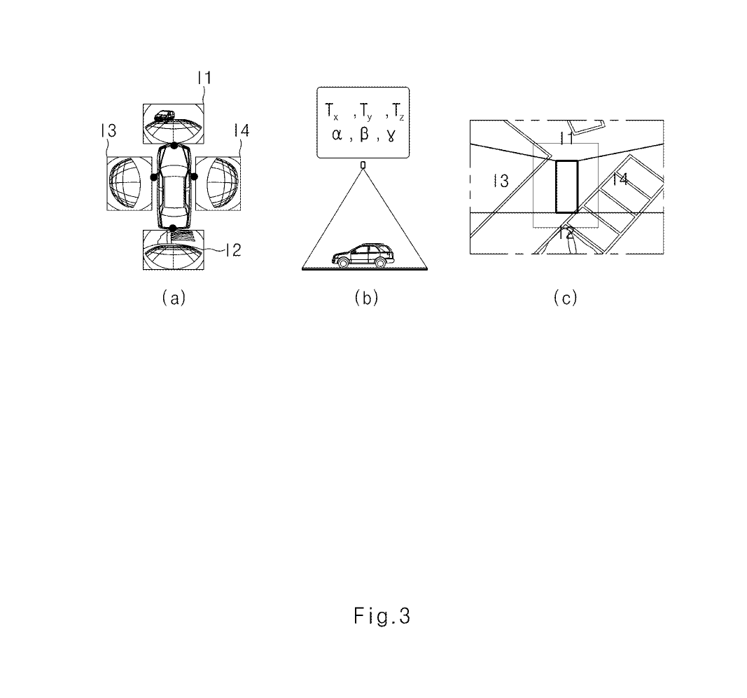

FIG. 3 is an exemplary view illustrating an operation of compounding an image in an apparatus for detecting a three dimensional object using an image around a vehicle according to an exemplary embodiment the present invention.

Referring to FIG. 3, the three dimensional object detection apparatus according to the present invention may collect a plurality of images I1, I2, I3 and I4 photographed through the plurality of imaging devices disposed on the front, rear, left and right sides of the vehicle, as shown in (a). In particular, the three dimensional object detection apparatus may set, by the processor, a virtual imaging device through mathematic modeling of each imaging device disposed on the front, rear, left and right sides of the vehicle, as shown in (b) of FIG. 3, and, may convert a view of respective images obtained in (a) into a top view to generate a composite image, as shown in (c).

In other words, the image I1 photographed through an imaging device disposed on the front side of the vehicle in (a) of FIG. 3 corresponds to I1 of the composite image of (c) and the image I2 photographed through an imaging device disposed on the rear side of the vehicle in (a) of FIG. 3 corresponds to I2 of the composite image of (c). Also, the image I3 photographed through an imaging device disposed on the left side of the vehicle in (a) of FIG. 3 corresponds to I3 of the composite image of (c) and the image I4 photographed through an imaging device disposed on the right side of the vehicle in (a) of FIG. 3 corresponds to I4 of the composite image of (c).

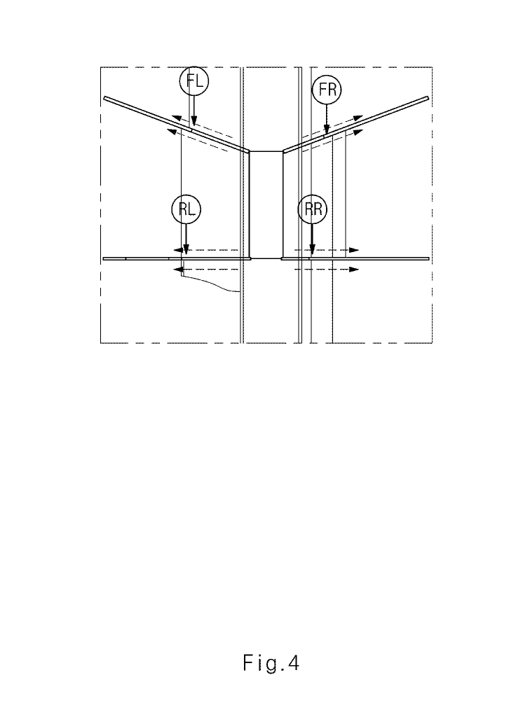

FIGS. 4 through 7 are exemplary views illustrating an operation of detecting a three dimensional object in an apparatus for detecting a three dimensional object using an image around a vehicle according to an exemplary embodiment the present invention.

FIG. 4 illustrates a boundary area between the plurality of top view images of the front, rear, left, and right sides of the vehicle in the composite image generated in FIG. 3.

Referring to FIG. 4, the boundary area between the top view images of the front, rear, left, and right sides of the vehicle in the composite image generated in (c) of FIG. 3 may be formed on front-left (FL), front-right (FR), rear-left (RL), and rear-right (RR) sides of the vehicle.

The three dimensional object detection apparatus may extract, by the processor, the boundary pattern, for example, a brightness, a color, a pixel value, a block value, and a character value of a plurality of neighboring images in each boundary area. In particular, the three dimensional object detection apparatus may extract the boundary pattern from an inner side to an outer side of the vehicle with respect to a boundary line between the neighboring images in the boundary area.

Moreover, the three dimensional object detection apparatus may analyze, by the processor, the correlation of the boundary pattern at a location corresponding to the neighboring images with respect to the boundary line of each boundary area and may determine a flat surface when the correlation is equal to or greater than a reference value and may determine that the three dimensional object is located in a corresponding area when the correlation is less than the reference value.

In other words, the three dimensional object detection apparatus may compare, by the processor, the boundary pattern, for example, the brightness, the color, the pixel value, the block value, and the character value of images at a corresponding location with respect to the boundary line between the neighboring images in each boundary area of the composite image and may determine the flat surface when the boundary pattern is similar to a reference pattern and may determine that the three dimensional object is located in a corresponding area when the boundary pattern is not similar to the reference pattern.

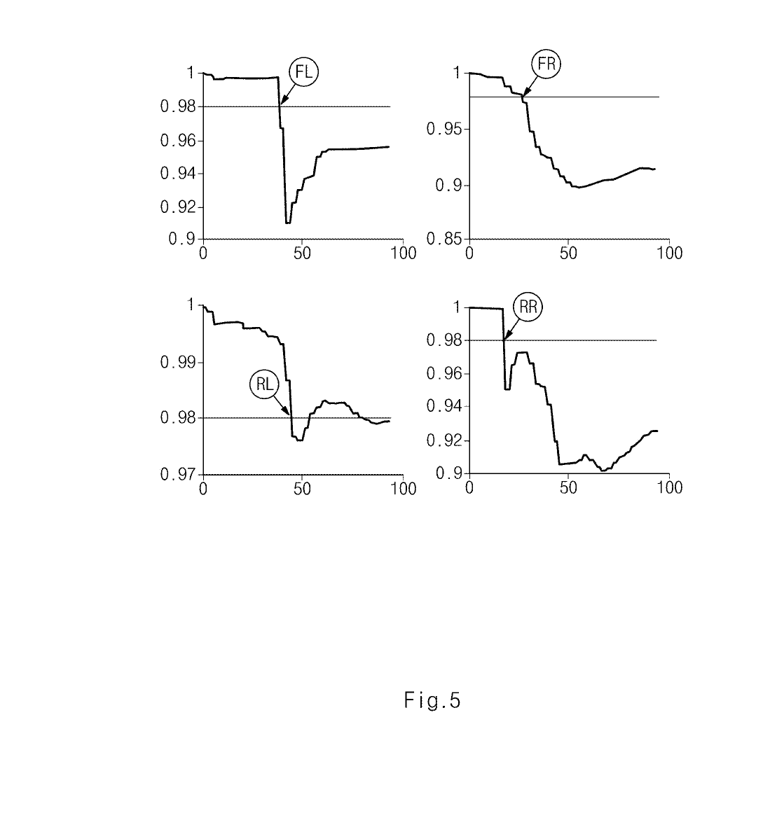

FIG. 5 shows a correlation of the boundary pattern between the neighboring images extracted in the boundary image of FIG. 4.

Referring to FIG. 5, the correlation of the boundary pattern may have a maximum value of 1 and a minimum value of 0 and the values range from 0 to 1 according to a difference of the boundary pattern between the neighboring images in each boundary area. In particular, a reference correlation for detecting the three dimensional object in each boundary area may be modified according to a setting, and in the exemplary embodiment of FIG. 5, the reference correlation for determining the three dimensional object may be 0.98.

In other words, when the correlation of the boundary pattern between neighboring images in each boundary area is equal to or greater than 0.98, the flat surface may be determined according to a higher correlation, and when the correlation is less than 0.98, the three dimensional object may be determined to exist, according to a lower correlation.

In a graph shown in FIG. 5, a horizontal axis is an order in which a block is arranged to extract the boundary pattern (for example, an innermost block is a first block and an outermost block is a 100th block) and a vertical axis is the correlation. In particular, the block arranged to extract the boundary pattern may have a width corresponding to three pixels; however, the present invention is not limited thereto.

Furthermore, in the correlation graph of the boundary area on the front and left side of the composite image, the correlation may be equal to or higher than 0.98 for the first to a 40th block and may be below 0.98 from 40th block. When the three dimensional object detection apparatus determines that the first to 40th blocks in a front and left direction of the vehicle are the flat surface, the three dimensional object may be located from the 40th block.

Additionally, in the correlation graph of the boundary area on the front and right side of the composite image, the correlation may be equal to or higher than 0.98 up to a 25th block and may be below 0.98 after the 25th block. When the three dimensional object detection apparatus determines that the first to 25th blocks in a front and right direction of the vehicle are the flat surface, the three dimensional object may be located from the 25th block.

Moreover, in the correlation graph of the boundary area on the rear and left side of the composite image, the correlation may be equal to or higher than 0.98 up to a 45th block and after a 55th block and the correlation may be below 0.98 between a 46th to a 55th blocks. When the three dimensional object detection apparatus determines that the three dimensional object exists from a 46th block to the 55th block in a rear and left direction of the vehicle, the remaining blocks may be the flat surface.

In addition, in the correlation graph of the boundary area on the front and left side in the composite image, the correlation may be equal to or higher than 0.98 up to a 20th block and the correlation may be below 0.98 after the 20th block. When the three dimensional object detection apparatus determines that the first to 20th blocks in a rear and right direction of the vehicle are the flat surface, the three dimensional object may be located after the 20th block.

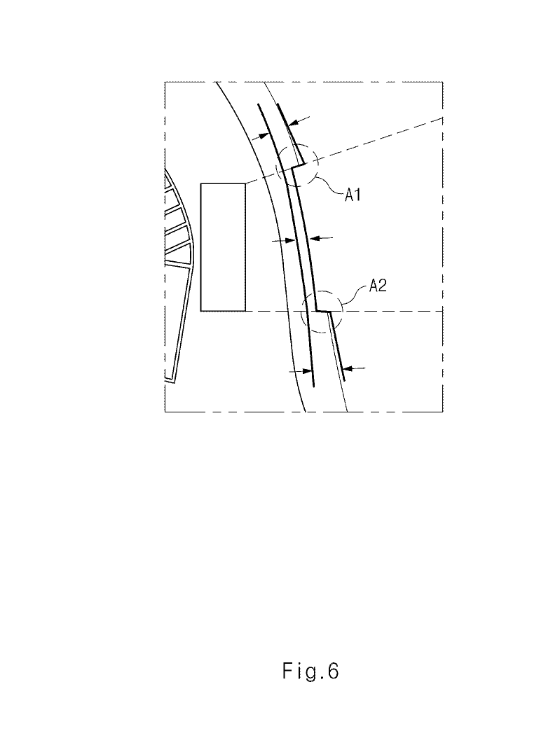

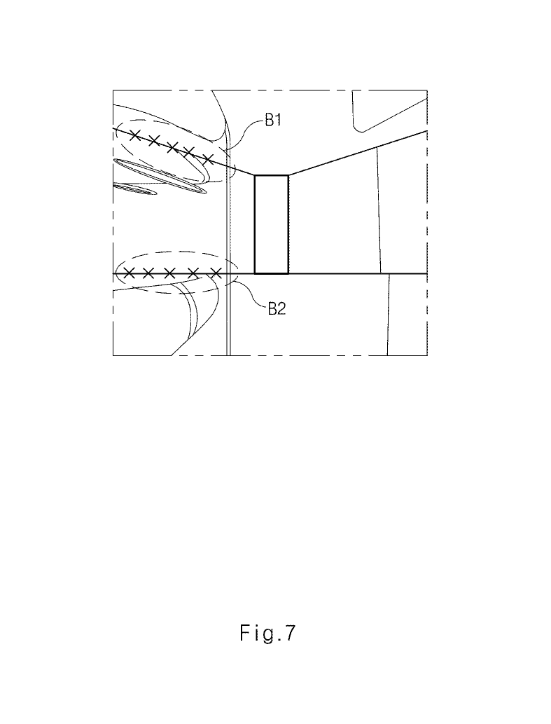

FIGS. 6 and 7 show an exemplary composite image of the plurality of images photographed in a real vehicle.

Referring to FIG. 6, a color difference is shown between the neighboring images in the boundary area in the front and right direction of the vehicle and in the boundary area in the rear and right direction. Particularly, a significant difference between the neighboring images is shown between an area A1 and an area A2.

Furthermore, the three dimensional object detection apparatus may compare, by the processor, a difference of the boundary pattern between the neighboring images in the boundary area in the front and right side of the composite image and in the boundary area in the rear and right side and may determine that the correlation between the neighboring images in the area A1 and the area A2 is lower. Thus, the three dimensional object detection apparatus may determine that the three dimensional object is located in the area A1 and the area A2 and may output three dimensional object detection information through the display means or the voice output means of the vehicle.

Moreover, referring to FIG. 7, a color difference and a brightness difference is shown between the neighboring images in the boundary area in the front and left direction of the vehicle and in the boundary area in the rear and left direction. Particularly, a significant difference between the neighboring images is shown between an area B1 and an area B2.

Furthermore, the three dimensional object detection apparatus may compare, by the processor, the difference of the boundary pattern between the neighboring images in the boundary area in the front and left side of the composite image and in the boundary area in the rear and left side and determines that the correlation between the neighboring images in the area B1 and the area B2 is lower. Thus, the three dimensional object detection apparatus may determine that the three dimensional object is located in the area B1 and the area B2 and may output the three dimensional object detection information through the display mean or the voice output means of the vehicle.

Accordingly, the three dimensional object detection apparatus may detect, by the processor, the 3D object using a technique of analyzing the correlation of the boundary pattern between the neighboring images so the 3D object may be detected without requiring an additional apparatus for detecting the 3D object and the driver may easily recognize the 3D object located in a blind spot.

An exemplary method of the three dimensional object detection apparatus according to the present invention configured above will be described in detail below.

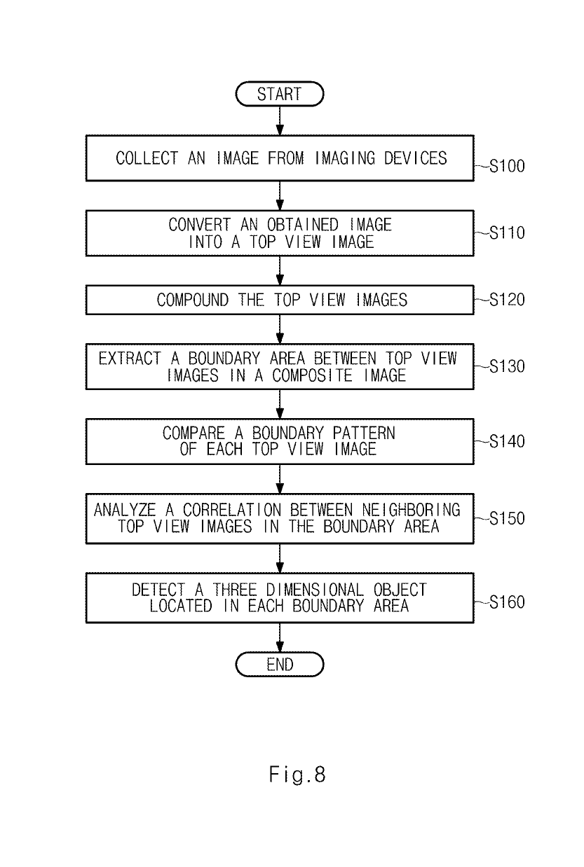

FIG. 8 is an exemplary flow chart illustrating a method of detecting a three dimensional object using an image around a vehicle according to an exemplary embodiment of the present invention.

Referring FIG. 8, the three dimensional object detection apparatus according to the present invention may collect, by a processor, an image from a plurality of imaging devices disposed on a front, a rear, a left side and a right side of the vehicle (S100) and may convert, by the processor, the image collected in S100 into a top view image (S110). In S110, a virtual imaging device corresponding to each imaging device may be set through a mathematic modeling based on positioning information of the plurality of imagine devices disposed on the front, rear, left or right sides of the vehicle and the top view of the image obtained in S100 may be converted using the set virtual imaging device. Next, the plurality of top view images may be compounded into one image (S120), by the processor. Additionally, when an AVM system is disposed in the vehicle, S110 and S120 may be omitted.

Furthermore, the three dimensional object detection apparatus may extract, by the processor, the boundary area between the plurality of top view images from the composite image generated in S120. In particular, the three dimensional object detection apparatus may extract the boundary pattern of the plurality of top view images included in the boundary area extracted in S130 to be compared, by the processor, therebetween (S140). In S140, a brightness, a color, and a character point of each top view image may be extracted, by the processor, from each boundary area in a pixel or a block and the brightness, the color, and the character point of a plurality of neighboring top view images in each boundary area may be compared, by the processor, therebetween.

Based on a comparison result of S140, the three dimensional object detection apparatus may analyze, by the processor, the correlation between the neighboring top view images in each boundary area (S150).

In one embodiment, the three dimensional object detection apparatus may compare, by the processor, the brightness of the neighboring top view images in a specific boundary area to analyze the correlation according to a difference in brightness between the neighboring top view images. In particular, when the brightness difference between the neighboring top view images is smaller, the correlation is analyzed to be higher, and when the brightness difference between the neighboring top view images is greater, the correlation is analyzed to be lower.

When a correlation analysis between the neighboring images in the boundary area in the front and left side, the front and right side, the rear and right side, and the rear and left side of the vehicle is completed, by the processor, in S150, the three dimensional object detection apparatus may detect, by the processor, the 3D object located in each boundary area based on an analysis result of S150 (S160).

In S160, the three dimensional object detection apparatus may detect, by the processor, the 3D object in the boundary area having a lower correlation between the neighboring images. When the 3D object is detected in S160, the three dimensional object detection apparatus may notify, by the processor, the driver of a 3D object detection result in a form of a text or a voice.

According to the present invention, by detecting the three dimensional object according to the correlation of the boundary pattern between neighboring images extracted from the boundary area between the top view images in the composite image in which the top views of the front, rear, left and right sides of the vehicle are compounded, the driver may easily recognize the 3D object located in a blind spot.

The three dimensional object detection apparatus according to the present invention may detect the three dimensional object using a technique of analyzing the correlation of the boundary pattern between the neighboring images such that the 3D object may be detected without requiring a separate apparatus for detecting the three dimensional object and the driver may easily recognize the three dimensional object located in the blind spot.

In the above, although the embodiments of the present invention have been described with reference to the accompanying drawings, a person skilled in the art should apprehend that the present invention can be embodied in other specific forms without departing from the technical spirit or essential characteristics thereof. Thus, the embodiments described above should be construed as exemplary in every aspect and not limiting.

What is claimed is:

1. An apparatus for detecting a three dimensional object using an image around a vehicle, the apparatus comprising:
a plurality of imaging devices disposed on a front, a rear, a left side, and a right side of the vehicle;
a processor configured to:
collect an image of the front, the rear, the left side, and the right side of the vehicle through a virtual imaging device generated using a mathematic modeling of each imaging device;
generate a composite image by compounding a plurality of top view images of the collected image from the front, the rear, the left side, and the right side of the vehicle;
analyze a boundary area between the plurality of top view images from the composite image to extract a boundary pattern of the plurality of top view images in each boundary area;
compare the boundary pattern of the plurality of top view images to analyze a correlation between a plurality of neighboring images in each boundary area; and
detect a three dimensional object disposed in each boundary area according to the correlation between the plurality of neighboring images in each boundary area.

2. The apparatus of claim 1, wherein the boundary pattern is selected from at least one of a group consisting of: a brightness, a color, and a character value in a pixel or a block of the plurality of top view images of the front, rear, left, and right sides of the vehicle in each boundary area.

3. The apparatus of claim 1, wherein the processor is further configured to analyze a higher correlation when a difference of the boundary pattern between the plurality of neighboring images in each boundary area is lower and analyzes a lower correlation when a difference of the boundary pattern between the plurality of neighboring images in each boundary area is higher.

4. The apparatus of claim 1, wherein the processor is further configured to detect the three dimensional object from a boundary area having a lower correlation between the plurality of neighboring images.

5. A method of detecting a three dimensional object using an image around a vehicle, the apparatus comprising:
collecting, by a processor, an image of a front, a rear, a left side, and a right side of the vehicle through a virtual imaging device generated using a mathematic modeling of the plurality of imaging devices disposed on the front, the rear, the left side and the right side of the vehicle;
generating, by the processor, a composite image by compounding a plurality of top view images of the image of the front, the rear, the left side, and the right side of the vehicle;
analyzing, by the processor, a boundary area between the plurality of top view images from the composite image to extract a boundary pattern of the plurality of top view images in each boundary area;
comparing, by the processor, the boundary pattern of the plurality of top view images to analyze a correlation between a plurality of neighboring images in each boundary area; and
detecting, by the processor, a three dimensional object disposed in each boundary area according to the correlation between the plurality of neighboring images in each boundary area.

6. The method of claim 5, wherein the boundary pattern is selected from at least one of a group consisting of: a brightness, a color, and a character value in a pixel or a block of the plurality of top view images in each boundary area.

7. The method of claim 5, wherein analyzing the correlation further comprises analyzing, by the processor, a higher correlation when a difference of the boundary pattern between the plurality of neighboring images in each boundary area is lower and analyzing, by the processor, a lower correlation when a difference of the boundary pattern between the plurality of neighboring images in each boundary area is higher.

8. The method of claim 5, wherein detecting the three dimensional object further comprises detecting, by the processor, the three dimensional object from the boundary area having a lower correlation between the plurality of neighboring images.

9. A non-transitory computer readable medium containing program instructions executed by a processor, the computer readable medium comprising:
program instructions that collect an image of the front, the rear, the left side, and the right side of the vehicle through a virtual imaging device generated using a mathematic modeling of each imaging device;
program instructions that generate a composite image by compounding a plurality of top view images of the collected image from the front, the rear, the left side, and the right side of the vehicle;
program instructions that analyze a boundary area between the plurality of top view images from the composite image to extract a boundary pattern of the plurality of top view images in each boundary area;
program instructions that compare the boundary pattern of the plurality of top view images to analyze a correlation between a plurality of neighboring images in each boundary area; and
program instructions that detect a three dimensional object disposed in each boundary area according to the correlation between the plurality of neighboring images in each boundary area.

10. The non-transitory computer readable medium of claim 9, wherein the boundary pattern is selected from at least one of a group consisting of: a brightness, a color, and a character value in a pixel or a block of the plurality of top view images of the front, rear, left, and right sides of the vehicle in each boundary area.

11. The non-transitory computer readable medium of claim 9, further comprising program instructions that analyze a higher correlation when a difference of the boundary pattern between the plurality of neighboring images in each boundary area is lower and analyzes a lower correlation when a difference of the boundary pattern between the plurality of neighboring images in each boundary area is higher.

12. The non-transitory computer readable medium of claim 9, further comprising program instructions that detect the three dimensional object from a boundary area having a lower correlation between the plurality of neighboring images.
